(19) United States
(12) Patent Application Publication
(10) Pub. No.: US 2026/0366354 A1
(43) Pub. Date: Nov. 19, 2026

(54) WINDOW REGULATOR

(71) Applicant: Johnan Manufacturing Inc., Ueda-shi (JP)

(72) Inventor: Akira WAKABAYASHI, Ueda-shi (JP)

(73) Assignee: Johnan Manufacturing Inc., Ueda-shi (JP)

(21) Appl. No.: 19/669,131

(22) Filed: May 6, 2026

(30) Foreign Application Priority Data
May 19, 2025 (JP) 2025-083664

(51) Int. Cl. E05F 15/689

(52) U.S. Cl. CPC E05F 15/6911; E05Y 2201/47; E05Y 2900/55

(57) ABSTRACT

A window regulator includes an outer tube through which a wire to pull a carrier plate is inserted, a support member that supports one end of the outer tube, and a slack removal mechanism that is arranged on the support member and absorbs slack of the wire by moving one end of the outer tube. The slack removal mechanism includes a ratchet member that is attached to the support member and includes ratchet teeth formed thereon, a movable-side member that is coupled to one end of the outer tube and is housed so as to be movable relative to the support member while engaging the ratchet teeth, and a biasing portion to bias the movable-side member in a sliding direction of the ratchet teeth, and wherein the ratchet member is configured to be attachable to the support member by inserting in a direction opposite to the sliding direction.

### CROSS-REFERENCE TO RELATED APPLICATIONS

The present patent application claims the priority of Japanese patent application No. 2025/083664 filed on May 19, 2025, and the entire contents of Japanese patent application No. 2025/083664 are hereby incorporated by reference.

### TECHNICAL FIELD

The present invention relates to a window regulator.

### BACKGROUND ART

A window regulator is known which includes a slack removal mechanism to eliminate slack of a wire (see Patent Literature 1). The window regulator includes an outer tube through which a wire (cable) is inserted, and a slack removal mechanism (a tensioning device) that absorbs slack of the wire by moving one end of the outer tube. The slack removal mechanism includes a movable-side member (an adjuster member) fixed to one end of the outer tube, a coil spring to bias the movable-side member, and a ratchet member (a locking member) engaging with the movable-side member.

In the window regulator, the biasing force of the coil spring presses the movable-side member, which causes the outer tube to curve (increases the degree of curvature) while shifting the engagement position of the movable-side member with the ratchet member. This applies tension to the wire, making it possible to absorb slack of the wire.

### CITATION LIST

### Patent Literature

Patent Literature 1: JP 2010/174593A

### SUMMARY OF INVENTION

However, during assembly work of the window regulator, after the movable-side member is attached until attachment of the wire is complete, it is necessary to either compress the coil spring or to prevent the movable-side member and the ratchet member from engaging. Therefore, there is a problem of poor ease of assembly.

It is an object of the invention to provide a window regulator that can improve ease of assembly.

An aspect of the invention provides a window regulator, comprising:
a. a carrier plate that supports a window glass;
b. a wire to pull the carrier plate;
c. an outer tube through which the wire is inserted;
d. a support member that supports one end of the outer tube; and
e. a slack removal mechanism that is arranged on the support member and absorbs slack of the wire by moving one end of the outer tube,
f. wherein the slack removal mechanism comprises a ratchet member that is attached to the support member and comprises ratchet teeth formed thereon, a movable-side member that is coupled to one end of the outer tube and is housed so as to be movable relative to the support member while engaging the ratchet teeth, and a biasing portion to bias the movable-side member in a sliding direction of the ratchet teeth, and wherein the ratchet member is configured to be attachable to the support member by inserting in a direction opposite to the sliding direction.

### Advantageous Effects of Invention

A window regulator according to an exemplary embodiment of the invention can improve ease of assembly.

### BRIEF DESCRIPTION OF DRAWINGS

FIG. 1 is a general schematic diagram illustrating a window regulator in an embodiment of the present invention and a vehicle door on which the window regulator is provided.

FIG. 2 is a front view showing the window regulator.

FIG. 3A is a front view showing a drive unit.

FIG. 3B is a rear view showing the drive unit.

FIG. 4A is a rear view showing a second tube attachment portion with a cover omitted

FIG. 4B is a rear view showing a mechanism housing portion with the cover omitted.

FIG. 5 is an exploded perspective view showing the second tube attachment portion.

FIG. 6A is a perspective view showing a plug.

FIG. 6B is a front view showing the plug.

FIG. 6C is a plan view showing the plug.

FIG. 6D is a right side view showing the plug.

FIG. 7A is a perspective view showing a pair of racks.

FIG. 7B is a front view showing the pair of racks.

FIG. 7C is a plan view showing the pair of racks.

FIGS. 8A to 8C are explanatory diagrams illustrating an operation of assembling the window regulator.

FIGS. 9A to 9C are explanatory diagrams illustrating the mechanism housing portion and therearound during the operation of assembling the window regulator.

FIG. 10A is a rear view showing the first modification of the second tube attachment portion.

FIG. 10B is a rear view showing the second modification of the second tube attachment portion.

### DESCRIPTION OF EMBODIMENTS

A window regulator in an embodiment of the invention will be described below with reference to the appended drawings. This window regulator is a raising/lowering device that is installed in a vehicle door provided on a vehicle (e.g., an automobile) and raises/lowers a window glass on the vehicle door. In particular, this window regulator is designed to improve ease of assembly of the slack removal mechanism which absorbs slack of the wire by bending the outer tube. Hereinafter, an ascending/descending direction of the window glass will be simply referred to as the ascending/descending direction. In addition, left, right, front, rear, up and down used in the following description are as defined in each drawing. In the present embodiment, a vehicle width direction coincides with a front-rear direction of the window regulator.

### Configuration of the window regulator

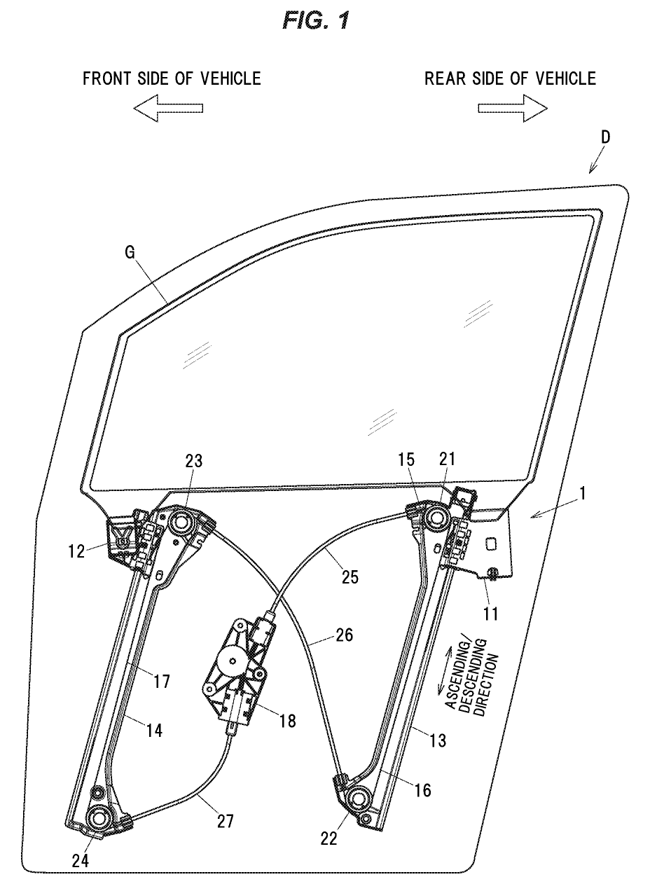

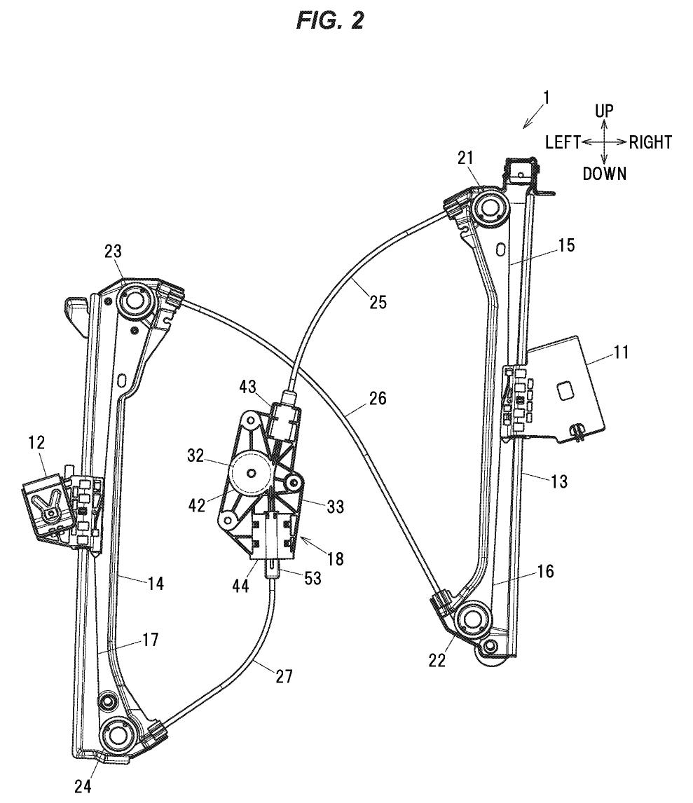

As shown in FIGS. 1 and 2, a window regulator 1 is installed on a vehicle door D and includes a first carrier plate 11 on the right side and a second carrier plate 12 on the left side that support a window glass G, a first guide rail 13 that supports the first carrier plate 11 so as to be slidable in the ascending/descending direction, a second guide rail 14 that supports the second carrier plate 12 so as to be slidable in the ascending/descending direction, three wires 15, 16, 17 that pull the first carrier plate 11 and the second carrier plate 12, and a drive unit 18 that drives the three wires 15, 16, 17. That is, this window regulator 1 is a wire driving-type window regulator to raise and lower the carrier plates 11, 12 using the wires 15, 16, 17 and is also a double-rail window regulator provided with two guide rails 13, 14.

The window regulator 1 also includes a first pulley 21 on the upper side and a second pulley 22 on the lower side that are arranged at upper and lower end portions of the first guide rail 13 and change the direction of the wires 15 and 16, a third pulley 23 on the upper side and a fourth pulley 24 on the lower side that are arranged at upper and lower end portions of the second guide rail 14 and change the direction of the wires 16 and 17, a first outer tube 25 which is arranged between the drive unit 18 and the first pulley 21 and through which the first wire 15 is inserted, a second outer tube 26 which is arranged between the second pulley 22 and the third pulley 23 and through which the second wire 16 is inserted, and a third outer tube 27 which is arranged between the fourth pulley 24 and the drive unit 18 and through which the third wire 17 is inserted.

The carrier plates 11 and 12 are each composed of a plate-shaped member formed of, e.g., a resin such as polyacetal, and are slidably supported respectively by the first guide rail 13 and the second guide rail 14. In addition, each of the carrier plates 11 and 12 is fitted with a glass holder (not shown) secured to the window glass G, and each of the carrier plates 11 and 12 supports the window glass G through the glass holder.

Each guide rail 13, 14 is formed by bending a long metal plate so as to be curved toward the outside of a vehicle cabin at a predetermined curvature, and is arranged so as to tilt to the rear side in a vehicle front-rear direction with respect to the vehicle door D. Then, the guide rails 13, 14 extend in the ascending/descending direction of the window glass G and respectively support the carrier plates 11 and 12 so as to be slidable in the ascending/descending direction.

The three wires 15, 16, 17 consist of the first wire 15 coupled at one end to a rotating drum 32 (described later) of the drive unit 18 and coupled at the other end to the first carrier plate 11 through the first pulley 21, the second wire 16 coupled at one end to the first carrier plate 11 and coupled at the other end to the second carrier plate 12 through the second pulley 22 and the third pulley 23, and the third wire 17 coupled at one end to the second carrier plate 12 and coupled at the other end to the rotating drum 32 through the fourth pulley 24. In other words, the three wires 15, 16, and 17 are routed in a horizontal “8” shape as a whole by the four pulleys 21 to 24.

The first outer tube 25 is attached at one end to the drive unit 18 and at the other end to the upper end portion of the first guide rail 13, and covers the first wire 15 between the drive unit 18 and the first pulley 21 so that the first wire 15 can freely move back and forth.

The second outer tube 26 is attached at one end to the lower end portion of the first guide rail 13 and at the other end to the upper end portion of the second guide rail 14, and covers the second wire 16 between the second pulley 22 and the third pulley 23 so that the second wire 16 can freely move back and forth.

The third outer tube 27 is arranged with one end attached to the drive unit 18 and the other end attached to the lower end portion of the second guide rail 14, and covers the third wire 17 between the fourth pulley 24 and the drive unit 18 so that the third wire 17 can freely move back and forth.

As shown in FIG. 2, the drive unit 18 has a motor with reducer (not shown), a cylindrical rotating drum 32 that is rotationally driven by the motor and rotates to take up and feed out (drive) the first wire 15 and the third wire 17, and a housing 33 that rotatably houses the rotating drum 32 and also holds the motor. The housing 33 is an example of the “support member”.

When the motor is driven in forward, the rotating drum 32 rotates in the forward direction and accordingly takes up the first wire 15 while feeding out the third wire 17. Thus, the first carrier plate 11 is pulled by the first wire 15 and the second carrier plate 12 is pulled through the first carrier plate 11 and the second wire 16, and the first carrier plate 11 and the second carrier plate 12 thus move upward in the ascending/descending direction. As a result, the window glass G attached to the first carrier plate 11 and the second carrier plate 12 is raised. On the other hand, when the motor is driven in reverse, the rotating drum 32 rotates in the reverse direction and accordingly takes up the third wire 17 while feeding out the first wire 15. Thus, the second carrier plate 12 is pulled by the third wire 17 and the first carrier plate 11 is pulled through the second carrier plate 12 and the second wire 16, and the first carrier plate 11 and the second carrier plate 12 thus move downward in the ascending/descending direction. As a result, the window glass G attached to the first carrier plate 11 and the second carrier plate 12 is lowered. In this manner, the window glass G is raised and lowered along the guide rails 13 and 14 (operations of raising and lowering the window glass G).

### Configuration of the housing

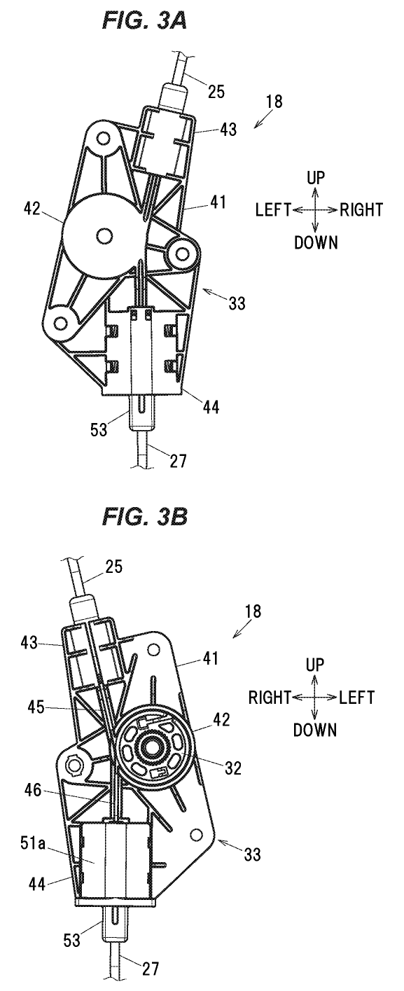

As shown in FIGS. 3A and 3B, the housing 33 has a main body 41, a drum housing portion 42 that is formed on the main body 41 at a center portion in the up-down direction and rotatably houses the rotating drum 32, a first tube attachment portion 43 that is formed at an upper portion of the main body 41 and supports one end of the first outer tube 25, a second tube attachment portion 44 that is formed (arranged) at a lower portion of the main body 41 and supports one end of the third outer tube 27, a first insertion groove 45 through which the first wire 15 is inserted from the first tube attachment portion 43 to the drum housing portion 42, and a second insertion groove 46 through which the third wire 17 is inserted from the second tube attachment portion 44 to the drum housing portion 42. The one end of the first wire 15 is introduced from the first tube attachment portion 43 into the drum housing portion 42 through the first insertion groove 45 and is coupled to the rotating drum 32. Likewise, the one end of the third wire 17 is introduced from the second tube attachment portion 44 into the drum housing portion 42 through the second insertion groove 46 and is coupled to the rotating drum 32. The second tube attachment portion 44 employs a slack removal mechanism that absorbs slack of the third wire 17 by moving the one end of the third outer tube 27, and the second tube attachment portion 44 is an example of the “slack removal mechanism”.

### Configuration of the second tube attachment portion

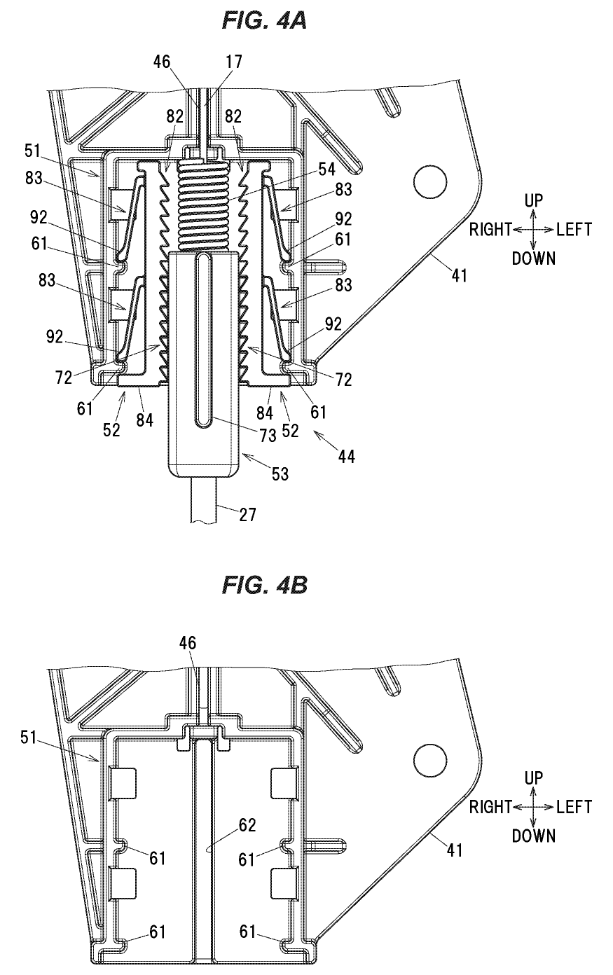

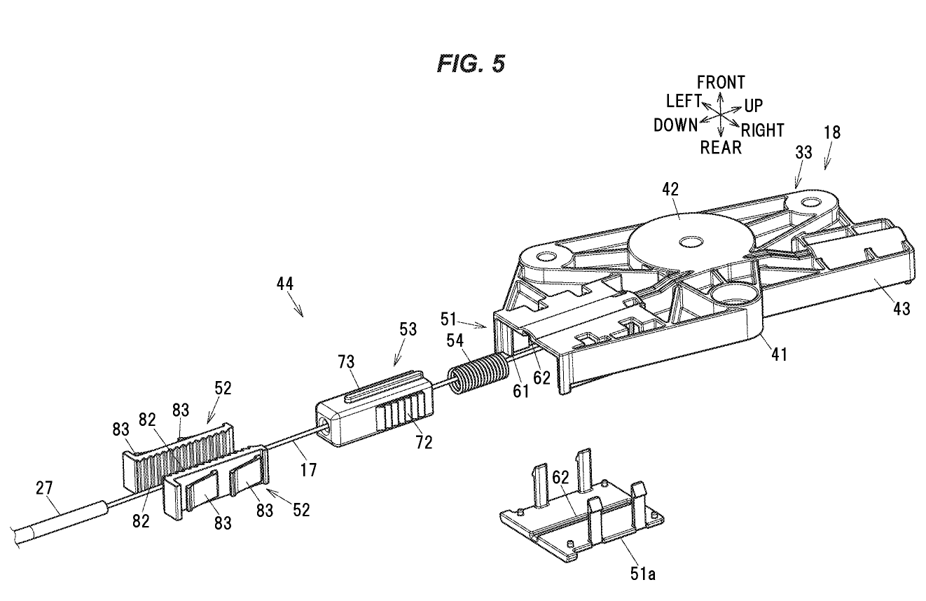

As shown in FIGS. 4A to 5, the second tube attachment portion 44 has a function of a slack removal mechanism that absorbs slack of the third wire 17 by moving one end of the third outer tube 27, and has a mechanism housing portion 51 formed on the main body 41, a pair of fixed-side racks 52, 52 which are attached to the mechanism housing portion 51 and have ratchet teeth 82 formed thereon, a movable-side plug 53 that is coupled to the one end of the third outer tube 27 and movably housed in the mechanism housing portion 51 while engaged with the ratchet teeth 82 of the pair of racks 52, 52, and a biasing spring 54 to bias the plug 53 downward. The rack 52 is an example of the “ratchet member”, and the plug 53 is an example of the “movable-side member”. The biasing spring 54 is an example of the “biasing portion”.

The mechanism housing portion 51 is closed by a cover 51a on the rear side, is formed in a box shape opening on the lower side, and houses the pair of racks 52, 52, the plug 53 and the biasing spring 54. In detail, as shown in FIGS. 4A and 4B, each of the right inner wall and left inner wall of the mechanism housing portion 51 has two upper and lower locking protrusions 61, 61, and the pair of racks 52, 52 are attached to the mechanism housing portion 51 by plate spring portions 83 (described later) of the racks 52 locked to the locking protrusions 61, 61. In addition, guide grooves 62 are formed on the front inner wall of the mechanism housing portion 51 and on the cover 51a, and the plug 53 is housed so as to be movable in the ascending/descending direction relative to mechanism housing portion 51 by engagement of guide ribs 73 (described later) of the plug 53 with the guide grooves 62. Furthermore, the biasing spring 54 is housed between the plug 53 and the upper inner wall of the mechanism housing portion 51. Each of the locking protrusions 61, 61 is preferably configured such that an upper surface is a surface parallel to the left-right and front-rear directions while a lower surface is an inclined surface that slopes inward in the left-right direction from below to above.

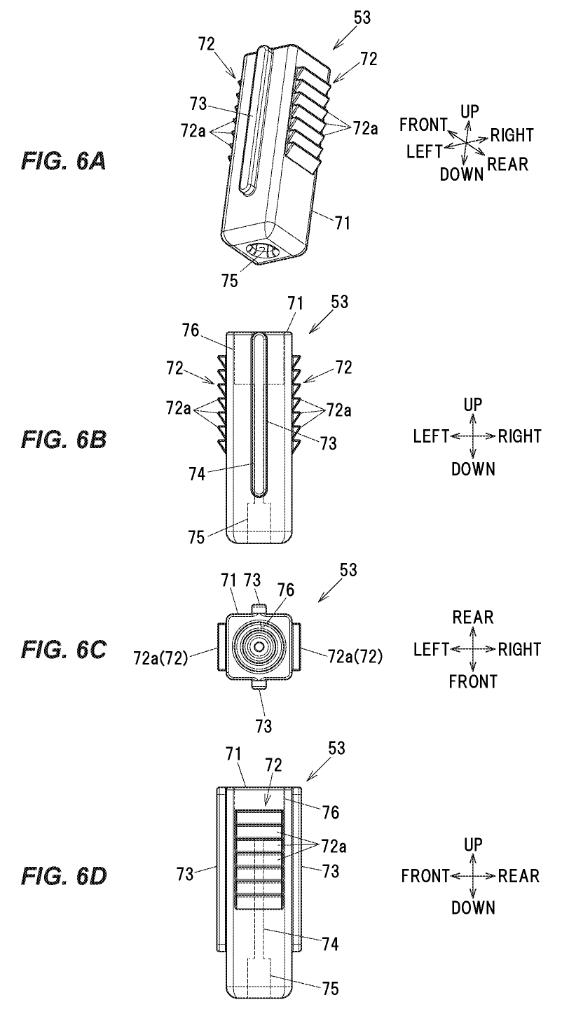

As shown in FIGS. 6A to 6D, the plug 53 has a block-shaped plug main body 71, a pair of left and right engagement teeth 72, 72 that are formed on the left and right surfaces of the plug main body 71 and engage with the ratchet teeth 82 of the pair of racks 52, 52, a pair of guide ribs 73, 73 formed on the front and rear surfaces of the plug main body 71, an insertion hole 74 which is formed inside the plug main body 71 and through which the third wire 17 is inserted, a substantially circular hole-shaped tube fixing portion 75 which is formed at the lower end of the insertion hole 74 and to which the one end of the third outer tube 27 is fixed, and a circular hole-shaped spring housing portion 76 formed at the upper end of the insertion hole 74 to house the biasing spring 54. The third outer tube 27 is coupled to the plug 53 by fixing the one end of the third outer tube 27 to the tube fixing portion 75.

The engagement teeth 72 are formed to have a shape of ratchet teeth in which seven engagement claws 72a are arranged in the up-down direction. Each engagement claw 72a is configured such that an upper surface is a locked surface locked by the ratchet teeth 82 and a lower surface is an inclined guide surface that slopes outward in the left-right direction from below to above.

As shown in FIGS. 4A and 4B, the biasing spring 54 is composed of a coil spring, with one end locked to the upper inner wall of the mechanism housing portion 51 and the other end locked to the bottom surface of the hole in the spring housing portion 76. By biasing the plug 53 downward (in the sliding direction of the ratchet teeth 82) by the biasing spring 54, the one end of the third outer tube 27 coupled to the plug 53 moves downward, causing the third outer tube 27 to curve. This extends the path of the third wire 17, thereby absorbing slack of the third wire 17.

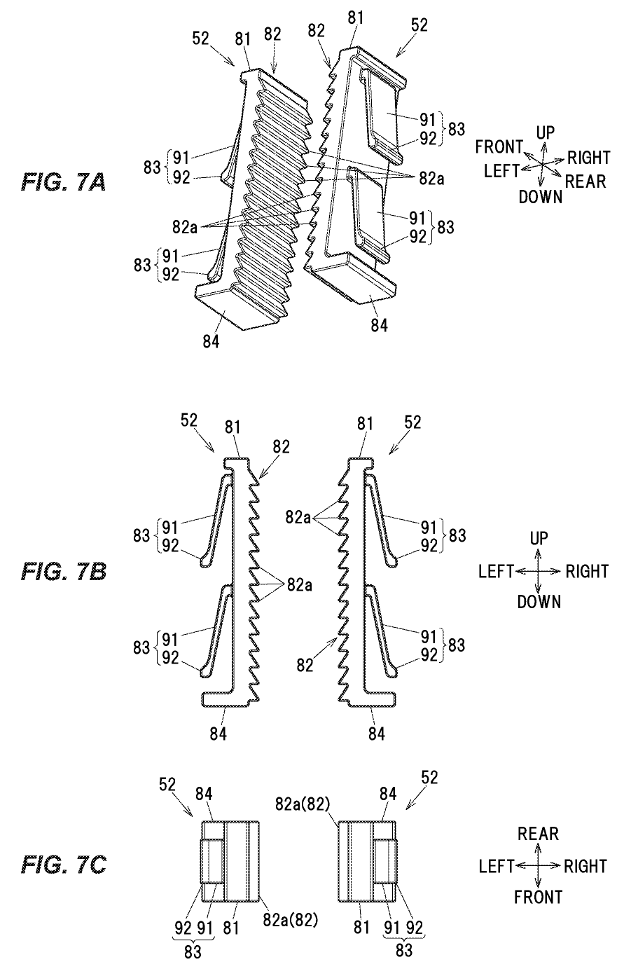

As shown in FIGS. 7A to 7C, each of the pair of racks 52 and 52 has a plate-shaped rack main body 81, the ratchet teeth 82 formed on a side surface of the rack main body 81 on the inner side in the left-right direction, two upper and lower plate spring portions 83 formed on a side surface of the rack main body 81 on the outer side in the left-right direction, and a pressure-receiving portion 84 formed at the lower end of the rack main body 81 and pressed when attaching the rack 52. The plate spring portion 83 is an example of the “spring portion”.

The pair of ratchet teeth 82, 82 are formed to have a shape in which plural claw portions 82a are arranged in the up-down direction. A lower surface of each claw portion 82a is a locking surface which faces the upper surface of (the engagement claw 72a of) the engagement teeth 72 of the plug 53 and locks the engagement teeth 72. Then, an upper surface of each claw portion 82a is an engagement surface which is an inclined surface sloping inward in the left-right direction from above to below and engages with the lower surface (the inclined guide surface) of the engagement claw 72a of the engagement teeth 72.

In the state in which the ratchet teeth 82 of the racks 52 are engaged with the engagement teeth 72 of the plug 53, the engagement between the lower surfaces of the claw portions 82a and the upper surfaces of the engagement claws 72a causes the claw portions 82a of the pair of ratchet teeth 82, 82 to lock the engagement teeth 72 of the plug 53, thereby restricting the upward movement of the plug 53. On the other hand, when the plug 53 tries to move downward while the ratchet teeth 82 of the racks 52 are engaged with the engagement teeth 72 of the plug 53, the engagement between the upper surfaces of the claw portions 82a and the lower surfaces of the engagement claws 72a causes the rack main bodies 81 to be guided outward in the left-right direction against the biasing force of the plate spring portions 83, thereby allowing the plug 53 to move downward. In this manner, the sliding direction of the ratchet teeth 82 is downward. When the third wire 17 is slacked, the biasing force of the biasing spring 54 causes the plug 53 to move downward, which changes the engagement position between the ratchet teeth 82 and the engagement teeth 72. The upward movement of the plug 53 is restricted in this state by the engagement between the ratchet teeth 82 and the engagement teeth 72, which maintains the curved state of the third outer tube 27 and thus maintains the state in which the slack of the third wire 17 is absorbed.

Each plate spring portion 83 is a resin plate spring and has a body portion 91 that extends diagonally downward from a side surface of the rack main body 81 toward the outside in the left-right direction, and an engagement portion 92 formed at a tip of the body portion 91. The body portion 91 is configured to be elastically deformable so as to swing in the left-right direction.

The engagement portion 92 has a side surface that faces the inner wall of the mechanism housing portion 51 and serves as a contact surface that comes into contact with the inner wall. By the contact of the engagement portion 92 with the inner wall of the mechanism housing portion 51, each plate spring portion 83 biases the rack 52 (the rack main body 81 and the ratchet teeth 82) toward the plug 53, with this inner wall acting as a support. That is, each plate spring potion 83 serves as a rack pressing portion that presses the rack 52 against the plug 53.

In addition, the engagement portion 92 is configured such that a lower surface is a locked surface facing the locking protrusion 61 of the mechanism housing portion 51 and being locked by this locking protrusion 61, and an upper surface is an inclined guide surface that slopes inward in the left-right direction from below to above.

When each rack 52 is inserted into the mechanism housing portion 51 upward from below, the engagement between the upper surface of the engagement portion 92 of each plate spring portion 83 and each locking protrusion 61 causes each plate spring portion 83 to be guided to swing inward in the left-right direction and contract in the left-right direction, allowing each engagement portion 92 to pass over each locking protrusion 61. In this state, as insertion of each rack 52 into the mechanism housing portion 51 progresses and each engagement portion 92 passes over each locking protrusion 61, the restoring force of the plate spring portion 83 causes the plate spring portion 83 to swing outward in the left-right direction and expand in the left-right direction. As a result, the lower surface of each engagement portion 92 faces the upper surface of each locking protrusion 61, and each engagement portion 92 is locked to each locking protrusion 61. The rack 52 is thereby attached to the mechanism housing portion 51. In this manner, the plate spring portion 83 constitutes an elastically deformable portion and a claw portion of the attachment structure in which the rack 52 is attached to the mechanism housing portion 51 (the housing 33) by the snap-fit method, and the rack 52 is configured to be attachable to the mechanism housing portion 51 by the snap-fit method which involves insertion in the upward direction.

In addition, due to the attachment structure with the plate spring portion 83 and the locking protrusion 61, the direction of attaching the rack 52 to the mechanism housing portion 51 is a direction (the upward direction) opposite to the sliding direction of the ratchet teeth 82, and the rack 52 is configured to be attachable to the mechanism housing portion 51 by inserting in a direction opposite to the sliding direction of the ratchet teeth 82. This allows the rack 52 to be attached after assembling the plug 53 and the third wire 17. That is, in the state after assembling the plug 53 and the third wire 17, the rack 52 is inserted between the plug 53 and the inner wall of the mechanism housing portion 51 and is attached. At this time, since relative movement of the plug 53 to the rack 52 is in the sliding direction, the rack 52 can be inserted and attached without being obstructed by the engagement between the ratchet teeth 82 and the engagement teeth 72.

When inserting the rack 52 between the plug 53 and the inner wall of the mechanism housing portion 51, the engagement portion 92 is pressed inward in the left-right direction due to the engagement between the engagement portion 92 of the plate spring portion 83 and the locking protrusion 61, and also the rack main body 81 is pressed outward in the left-right direction due to the engagement between the ratchet teeth 82 and the engagement teeth 72. However, the plate spring portion 83 does not break or undergo plastic deformation even if these pressings occur simultaneously.

### Description of an operation of assembling the window regulator

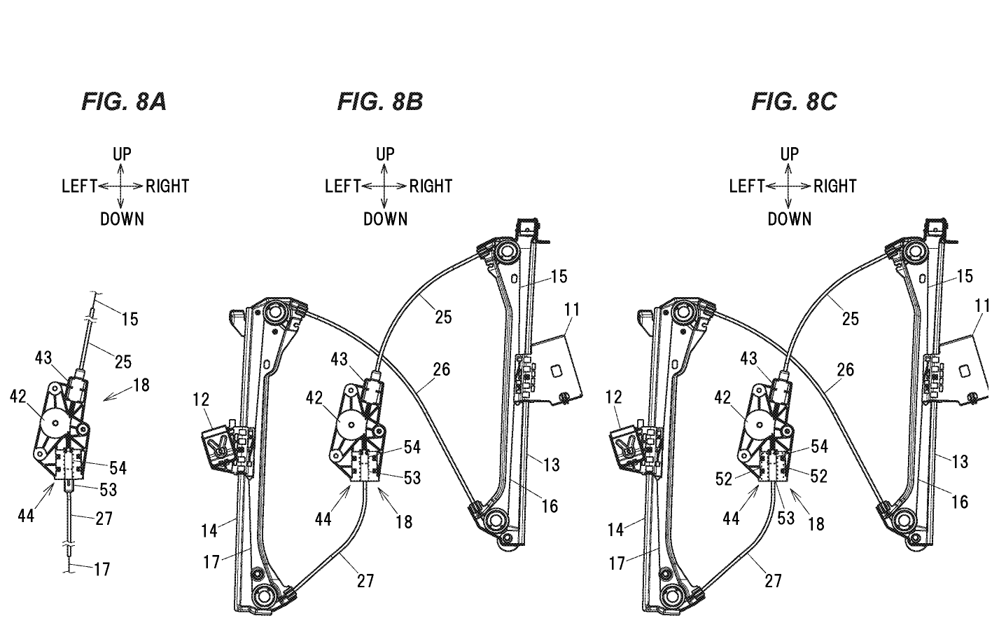

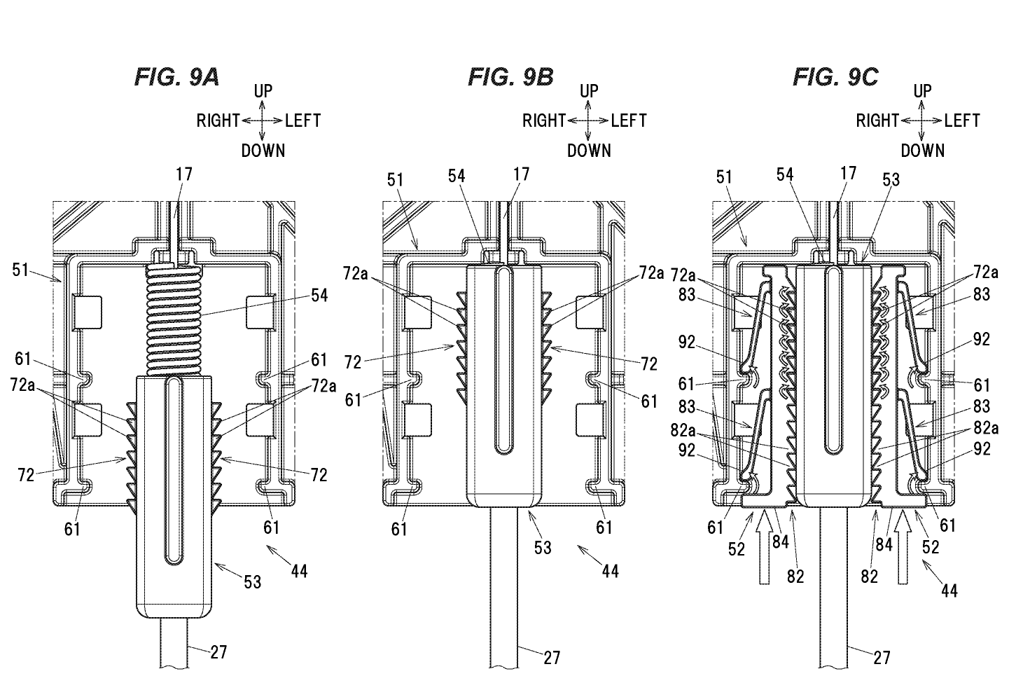

Next, an operation of assembling the window regulator 1 will be described with reference to FIGS. 8A to 9C. In the operation of assembling the window regulator, first, as shown in FIGS. 8A and 9A, after the rotating drum 32 is housed in the housing 33, one end of the first wire 15 and one end of the third wire 17 are introduced into the drum housing portion 42 through the first insertion groove 45 and the second insertion groove 46 and are coupled to the rotating drum 32. After that, the plug 53 coupled to one end of the third outer tube 27 and the biasing spring 54 are housed in the mechanism housing portion 51 while passing the third wire 17 through the third outer tube 27, the plug 53 and the biasing spring 54, thereby assembling the plug 53 and the biasing spring 54 to the housing 33. In addition, one end of the first outer tube 25 is coupled to the first tube attachment portion 43 while passing the first wire 15 through the first outer tube 25.

Next, as shown in FIG. 8B, the first carrier plate 11, the first pulley 21 and the second pulley 22 are assembled to the first guide rail 13, and the second carrier plate 12, the third pulley 23 and the fourth pulley 24 are assembled to the second guide rail 14. After that, the other end of the first wire 15 is attached to the first carrier plate 11 while routing the first wire 15 over the first pulley 21. In addition, one end of the second wire 16 is attached to the first carrier plate 11 and the other end of the second wire 16 to the second carrier plate 12 while passing the second wire 16 through the second outer tube 26 and routing the second wire 16 over the second pulley 22 and the third pulley 23. Furthermore, the other end of the third wire 17 is attached to the second carrier plate 12 while routing the third wire 17 over the fourth pulley 24. After that, the other end of the first outer tube 25 is attached to the upper end portion of the first guide rail 13. In addition, one end of the second outer tube 26 is attached to the lower end portion of the first guide rail 13 and the other end of the second outer tube 26 is attached to the upper end portion of the second guide rail 14. Furthermore, the other end of the third outer tube 27 is attached to the lower end portion of the second guide rail 14. By attaching the other end of the third wire 17 to the second carrier plate 12 and the other end of the third outer tube 27 to the lower end portion of the second guide rail 14, the plug 53 is pressed by the third outer tube 27 to cause the biasing spring 54 to be compressed as shown in FIG. 9B, and the assembly of the third wire 17 and the third outer tube 27 is completed.

After that, as shown in FIGS. 8C and 9C, the pair of racks 52, 52 are inserted upward through the opening of the mechanism housing portion 51 and attached to the mechanism housing portion 51 by being inserted between the plug 53 and the inner wall of the mechanism housing portion 51. That is, the right rack 52 is inserted upward through the opening of the mechanism housing portion 51 and is inserted and attached between the plug 53 and the right inner wall of the mechanism housing portion 51. The left rack 52 is also inserted upward through the opening in the mechanism housing portion 51 and is inserted and attached between the plug 53 and the left inner wall of the mechanism housing portion 51. At this time, the ratchet teeth 82 of the rack 52 engage the engagement teeth 72 of the plug 53, and as the rack 52 (the rack main body 81 and the ratchet teeth 82) is guided inward in the left-right direction due to the engagement between the upper surfaces of the claw portions 82a and the lower surfaces of the engagement claws 72a, the ratchet teeth 82 move over each engagement claw 72a. In addition, due to the engagement of the upper surface of the engagement portion 92 of each plate spring portion 83 and each locking protrusion 61, each engagement portion 92 is guided inward in the left-right direction and passes over each locking protrusion 61. This allows the rack 52 to be attached to the mechanism housing portion 51 without being obstructed by the locking protrusions 61 and the engagement teeth 72.

### Functions and Effects of the embodiment

The configuration of the above embodiment can improve ease of assembly of the window regulator 1 since the rack 52 is configured to be attachable to the housing 33 (the mechanism housing portion 51) by inserting in a direction opposite to the sliding direction of the ratchet teeth 82.

That is, a known window regulator is configured such that the rack 52 is first attached to the mechanism housing portion 51, and then, the plug 53, the biasing spring 54 and the third wire 17 are assembled. Therefore, after assembling the plug 53 and the biasing spring 54 until completing the assembly of the third wire 17 (until attaching the other end of the third wire 17 to the second carrier plate 12 while routing the third wire 17 over the fourth pulley 24), the plug 53 moves from its initial position due to the biasing force of the biasing spring 54 and is locked in that state by the rack 52. This causes a problem that the function of eliminating slack of the third wire 17 fails to work properly. For this reason, it is necessary to either compress the biasing spring 54 or to prevent the rack 52 and the plug 53 from engaging after assembling the plug 53 and the biasing spring 54 until completing the assembly of the third wire 17.

In contrast, in the above embodiment, since it is configured such that the rack 52 can be attached by inserting into the mechanism housing potion 51 in a direction opposite to the sliding direction of the ratchet teeth 82, it is possible to insert the rack 52 between the inner wall of the mechanism housing portion 51 and the plug 53 without being obstructed by the engagement between the ratchet teeth 82 and the engagement teeth 72, hence, it is possible to attach the rack 52 after assembling the plug 53, the biasing spring 54 and the third wire 17. This eliminates the need of compressing the biasing spring 54 or preventing the rack 52 and the plug 53 from engaging after assembling the plug 53 and the biasing spring 54 until completing the assembly of the third wire 17, hence, the ease of assembly of the slack removal mechanism can be improved and the ease of assembly of the window regulator 1 can be improved. In addition, the window regulator 1 can be easily assembled with a simple configuration.

In addition, the configuration of the above embodiment allows the rack 52 and the plug 53 to be assembled without aligning the ratchet teeth 82 of the rack 52 with the engagement teeth 72 of the plug 53. Therefore, the window regulator 1 can be assembled more easily.

In addition, in the configuration of the above embodiment, since the slack removal mechanism for the third wire 17 is adopted, slack of the third wire 17 when occurred can be eliminated. It is thereby possible to improve the response speed of the operation of raising and lowering the window glass G.

In addition, in the configuration of the above embodiment, since the rack 52 can be attached to the housing 33 (the mechanism housing portion 51) using the snap-fit method, the rack 52 can be attached more easily.

In addition, in the configuration of the above embodiment, the plate spring portion 83 constitutes the elastically deformable portion in the snap-fit attachment structure. Since the plate spring portion 83 also serves as this elastically deformable portion, the window regulator 1 can have a simpler configuration.

In addition, in the configuration of the above embodiment, the rack 52 has the pressure-receiving portion 84. Therefore, when inserting the rack 52 between the plug 53 and the inner wall of the mechanism housing portion 51, the rack 52 can be easily pushed in by pressing the pressure-receiving portion 84 with a person’s hand. This makes it easier to attach the rack 52 to the mechanism housing portion 51.

### Other Embodiments

Although the embodiment of the invention has been described, the invention according to claims is not to be limited to the embodiment described above. Further, please note that not all combinations of the features described in the embodiment are necessary to solve the problem of the invention. The invention can be appropriately modified and implemented without departing the gist thereof.

For example, the configuration of the above embodiment is such that the second tube attachment portion 44 has two racks 52, 52 and the plug 53 is arranged so as to be sandwiched between the two racks 52, 52, but the configuration may be such that the second tube attachment portion 44 has only one rack 52.

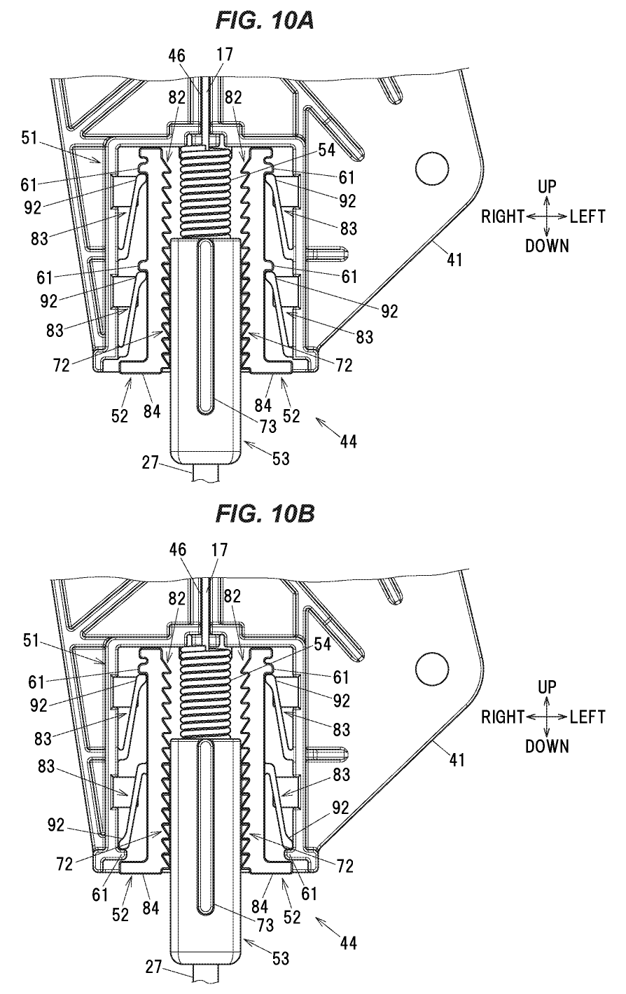

In addition, the configuration of the above embodiment is such that the plate spring portions 83 are formed on the rack 52, but the configuration is not limited thereto as long as the plate spring portions 83 are formed on one of the rack 52 and the mechanism housing portion 51 (the housing 33). That is, the configuration may be such that the plate spring portions 83 are formed on the mechanism housing portion 51, as shown in FIG. 10A. Alternatively, the configuration may be such that, e.g., some of the plate spring portions 83 are formed on the rack 52 and the remaining plate spring portions 83 are formed on the mechanism housing portion 51, as shown in FIG. 10B.

In addition, the configuration of the above embodiment is such that two plate spring portions 83 are provided on a side surface of each rack 52, but the configuration may be such that only one plate spring portion 83 is provided on a side surface of each rack 52, or the configuration may be such that three or more plate spring portions 83 are provided on a side surface of each rack 52.

In addition, the configuration of the above embodiment is such that the plate spring portion 83 constitutes the elastically deformable portion and the claw portion in the snap-fit attachment structure, but the configuration is not limited thereto. That is, the configuration may be such that the second tube attachment portion 44 has the elastically deformable portion and the claw portion of the snap-fit attachment structure separate from the plate spring portion 83. In such a case, the configuration may be such that the plate spring portion 83 is formed as a separate component from the rack 52 and the housing 33.

In addition, the configuration of the above embodiment is such that the rack 52 is attached to the mechanism housing portion 51 using the snap-fit method, but the configuration is not limited thereto as long as the rack 52 is inserted into and attached to the mechanism housing portion 51. For example, the configuration may be such that the rack 52 is fitted into and attached to the mechanism housing portion 51.

In addition, the configuration of the above embodiment is such that a plate spring in a straight plate shape extending linearly when viewed in the front-rear direction is used as the plate spring portion 83, but a plate spring in a curved plate shape curved in an arc shape when viewed in the front-rear direction may be used as the plate spring portion 83, or it may be configured to use a plate spring in a “U” or “V” shape when viewed in the front-rear direction. Furthermore, the spring portion is not limited to the plate spring portion 83 as long as it biases the rack 52 toward the plug 53, and the configuration may be such that a coil spring, such as a torsion coil spring, is used.

In addition, the configuration of the above embodiment is such that the engagement teeth 72 include seven engagement claws 72a, but the engagement teeth 72 may include any number of engagement claws 72a. That is, the configuration may be such that the engagement teeth 72 include only one, or not more than six engagement claws 72a, or the engagement teeth 72 include not less than eight engagement claws 72a.

In addition, the configuration of the above embodiment is such that the second tube attachment portion 44 has the ratchet teeth 82 on the fixed-side member (the rack 52) and the engagement teeth 72 to be engaged with the ratchet teeth 82 on the movable-side member (the plug 53), but the configuration may be such that the ratchet teeth 82 is provided on the movable-side member (the plug 53) and the engagement teeth 72 on the fixed-side member (the rack 52).

In addition, the configuration of the above embodiment is such that the rear side of the mechanism housing portion 51 is closed by the cover 51a which is a separate component, but the configuration may be such that the mechanism housing portion 51 (the housing 33) and the cover 51a are formed integrally.

In addition, the configuration of the above embodiment is such that the pair of racks 52, 52 are simultaneously inserted and simultaneously attached, but the configuration may be such that one of the pair of racks 52, 52 is attached and the other rack 52 is then attached.

In addition, the invention is applied to the second tube attachment portion 44 in the above embodiment, but the invention may be applied to the first tube attachment portion 43. That is, the configuration may be such that the structure of the slack removal mechanism adopted for the second tube attachment portion 44 is provided on the first tube attachment portion 43. Furthermore, the configuration may be such that support members to support ends of the outer tubes 25, 26, and 27 are arranged at the upper and lower ends of each guide rail 13, 14, and the structure of the slack removal mechanism adopted for the second tube attachment portion 44 is provided on these support members.

In addition, the invention is applied to the double-rail window regulator 1 having two guide rails 13 and 14 in the above embodiment, but it is not limited thereto. For example, the invention may be applied to a delta-type window regulator having one guide rail 13, or to a rail-less type window regulator having no guide rail 13.

### REFERENCE SIGNS LIST

1 WINDOW REGULATOR
12 SECOND CARRIER PLATE
17 THIRD WIRE
27 THIRD OUTER TUBE
33 HOUSING
44 SECOND TUBE ATTACHMENT PORTION
52 RACK
53 PLUG
54 BIASING SPRING
82 RATCHET TEETH
83 PLATE SPRING PORTION
G WINDOW GLASS

1. A window regulator, comprising:
a carrier plate that supports a window glass;
a wire to pull the carrier plate;
an outer tube through which the wire is inserted;
a support member that supports one end of the outer tube; and
a slack removal mechanism that is arranged on the support member and absorbs slack of the wire by moving one end of the outer tube,
wherein the slack removal mechanism comprises a ratchet member that is attached to the support member and comprises ratchet teeth formed thereon, a movable-side member that is coupled to one end of the outer tube and is housed so as to be movable relative to the support member while engaging the ratchet teeth, and a biasing portion to bias the movable-side member in a sliding direction of the ratchet teeth, and wherein the ratchet member is configured to be attachable to the support member by inserting in a direction opposite to the sliding direction.

2. The window regulator according to claim 1, wherein the ratchet member is configured to be attachable to the support member by a snap-fit method which involves insertion in the direction opposite to the sliding direction.

3. The window regulator according to claim 2, wherein one of the ratchet member and the support member comprises a spring portion to bias the ratchet member toward the movable-side member, and wherein the spring portion constitutes an elastically deformable portion of an attachment structure in which the ratchet member is attached by the snap-fit method.
